(19) United States
(12) Patent Application Publication
(10) Pub. No.: US 2018/0056560 A1
(43) Pub. Date: Mar. 1, 2018

(54) RESIN COMPOSITION FOR MAKING INSIDE DOOR HANDLE WITH SKIN-CORE STRUCTURE, METHOD FOR MANUFACTURING INSIDE DOOR HANDLE USING THE SAME, AND ARTICLE THEREOF

(71) Applicants: Hyundai Motor Company, Seoul (KR); Kia Motors Corporation, Seoul (KR); LG CHEM, LTD., Seoul (KR)

(72) Inventors: Jae Sik SEO, Suwon-si (KR); Sung Ho YOON, Busan (KR); Woo Chul JUNG, Bucheon-si (KR); Jeong Moo LEE, Daejeon (KR); Cheol Hwan HWANG, Daejeon (KR); Woo Young PARK, Daejeon (KR); Dong Chul SHIM, Daejeon (KR)

(73) Assignees: Hyundai Motor Company, Seoul (KR); Kia Motors Corporation, Seoul (KR); LG CHEM, LTD., Seoul (KR)

(21) Appl. No.: 15/376,926

(22) Filed: Dec. 13, 2016

(30) Foreign Application Priority Data
Aug. 25, 2016 (KR) 10-2016-0108511

(51) Int. Cl. B29C 45/16; B29C 45/00; E05B 85/12

(52) U.S. Cl. CPC B29C 45/1676; B29C 45/1645; B29K 2055/02; B29C 45/0005; E05B 85/12; B29C 45/0001

(57) ABSTRACT

A resin composition useful for making an inside door handle with a skin-core structure made by using co-injection, an inside door handle manufactured using the resin composition, and a method for manufacturing such a door handle are provided herein.

### CROSS-REFERENCE TO RELATED APPLICATION

The present application claims priority to Korean Patent Application No. 10-2016-0108511 filed on Aug. 25, 2016, the entire contents of which are incorporated herein by reference.

### BACKGROUND

### Field of the Invention

The present invention relates to a resin composition useful for making an inside door handle with a skin-core structure made by using co-injection, an inside door handle manufactured using the same, and a method for manufacturing the same. More particularly, it relates to an inside door handle with a closed skin-core structure being manufactured by co-injecting a skin portion and a core portion made of different materials with a time difference and thus having excellent mechanical property and plating property.

### Description of Related Art

An inside door handle for a vehicle has been generally manufactured by a general injection method of injecting melt plastic into a mold and cooling and ejecting the melt plastic (see FIG. 1A). The inside door handle manufactured by the injection molding becomes a final completed product through chemical plating or electroplating again.

However, in the general injection method disclosed in the related art, the injection molding may be performed by only a single material, or a mixed resin of ABS and PC. ABS is widely used due to an excellent plating property, but is vulnerable in terms of a mechanical property compared with other engineering plastics. In order to compensate for the mechanical property while maintaining plating performance, two-shot injection method with two molds can be used. In this method a primary injection is performed in a first mold and then secondary injection is performed by inverting the mold in order to use different materials having the desired properties (see FIG. 1B). However, in the case of the two-shot injection, dedicated molds and injection equipment are required. The injection can be applied to only different materials having chemical bonding force. Another disadvantage of this method is that it is impossible to provide a door handle with a completely closed type structure. In other words, by using the two molds, since a surface facing the mold is present, it is difficult to implement the closed type structure.

As a result, there is a need for compositions and method for manufacturing an inside door handle having a closed type structure, a desirable appearance, and desirable mechanical properties.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for manufacturing an inside door handle, wherein the method includes performing injection using co-injection rather than a general injection method or a two-shot injection method. Also provided herein are compositions of a skin portion and a core portion of specific materials that improve a mechanical property and a plating property of a sealed and completely closed type inside door handle. Such a door handle can be manufactured economically by applying the resin composition and method disclosed herein. The present invention provides an improved plating property and overcomes plating releasing problems that can arise when using general injection methods and two-shot injection methods described in the prior art.

Therefore, an embodiment of the present invention is to provide a resin composition for making an inside door handle with a skin-core structure with an improved mechanical property and an excellent plating property.

Another embodiment of the present invention is to provide a method for manufacturing an inside door handle with a closed type skin-core structure which has complete moldability and is made by co-injection using the composition.

Still another embodiment of the present invention is to provide an inside door handle with a closed type skin-core structure manufactured by the manufacturing method.

In one aspect, the present invention provides a resin composition for making an inside door handle with a skin-core structure in which a skin portion is made of a composition comprising an acrylonitrile-butadiene-styrene (ABS) resin alone or a mixture of a range from about 50 wt % to 60 wt % of an acrylonitrile-butadiene-styrene (ABS) resin and a range from about 40wt % to 50 wt % of a polycarbonate (PC) resin, and a core portion is made of a composition comprising from about 60 wt % to 90 wt % of a core portion resin comprising the ABS resin and the PC resin and from about 10 wt % to 40 wt % of glass fiber for reinforcing stiffness.

In another aspect, the present invention provides a method for manufacturing an inside door handle with a skin-core structure which is made by co-injecting a skin portion composition and a core portion composition with a time difference using the above composition.

In still another aspect, the present invention provides an inside door handle with a closed type skin-core structure which is made by co-injecting the composition described herein.

According to the present invention, the composition for the inside door handle has an improved mechanical property and excellent plating property and moldability. And thus the inside door handle manufactured by using the composition has excellent operability and quality. Further, in the manufacturing method according to the present invention, the inside door handle has a skin-core structure made of different materials and the skin-core structure is sealed to have a completely closed structure, thereby ensuring high-quality.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A illustrates a process schematic diagram of a general injection method used for manufacturing an inside door handle in the related art. FIG. 1B illustrates a two-shot injection method (b) capable of injecting different materials for manufacturing an inside door handle in the related art;

FIG. 2 illustrates a process schematic diagram of an embodiment of a co-injection method according to the present invention;

FIG. 3 illustrates a cross section of an inside door handle manufactured by an embodiment of the manufacturing method according to the present invention;

FIG. 4 is a result obtained by measuring whether core surfacing occurs according to a filling ratio of a core portion.

FIG. 5 illustrates an external appearance of a door handle having 45% of a filling ratio of a core portion during actual injection molding.

FIG. 6 shows an appearance of an etching surface measured by using a scanning electron microscope.

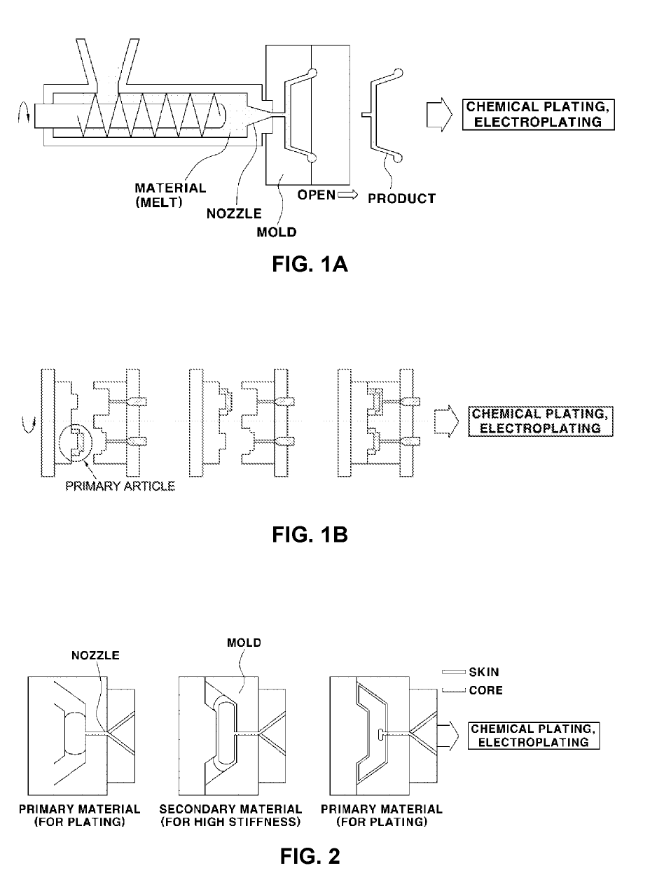

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several FIGS. of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described below in more detail as one exemplary embodiment.

The present invention provides a composition for making an inside door handle having a skin portion and a core portion made of different materials. In some embodiments, the composition of the skin portion comprises an acrylonitrile-butadiene-styrene (ABS) resin alone or a mixture of an acrylonitrile-butadiene-styrene (ABS) resin and a polycarbonate (PC) resin. A core portion composition comprises from about 60 wt % to about 90 wt % (e.g., about 60 wt %, 65 wt %, 70 wt %, 75 wt %, 80 wt %, 85 wt %, or about 90 wt %) of a core portion resin comprising an acrylonitrile-butadiene-styrene (ABS) resin and a polycarbonate (PC) resin and from about 10 wt % to about 40 wt % (e.g., about 10 wt %, 15 wt %, 20 wt %, 25 wt %, 30 wt %, 35 wt %, or about 40 wt %) of glass fiber for reinforcing stiffness.

In some instances, the skin portion uses preferably the ABS resin alone and more preferably, a mixture of an ABS resin and a PC resin. Particularly, the skin portion composition comprises from about 50 wt % to about 60 wt % (e.g., about 50 wt %, 51 wt %, 52 wt %, 53 wt %, 54 wt %, 55 wt %, 56 wt %, 57 wt %, 58 wt %, 59 wt % or 60 wt %) of the ABS resin and from about 40 wt % to about 50 wt % (e.g., about 40 wt %, 41 wt %, 42 wt %, 43 wt %, 44 wt %, 45 wt %, 46 wt %, 47 wt %, 48 wt %, 49 wt % or 50 wt %) of the PC resin. When the ABS resin is less than 50 wt %, there is a limitation in that plating adhesion is insufficient, and when the PC resin is less than 40 wt %, an effect of improving impact strength and a mechanical property is slight, and thus it is exemplary that the resins are used within the range.

In some cases, the core portion composition comprises from about 60 wt % to about 90 wt % (e.g., about 60 wt %, 65 wt %, 70 wt %, 75 wt %, 80 wt %, 85 wt %, or about 90 wt %) of a core portion resin comprising an ABS resin and a PC resin and 10 to 40 wt % (e.g., about 10 wt %, 15 wt %, 20 wt %, 25 wt %, 30 wt %, 35 wt %, or about 40 wt %) of glass fiber for reinforcing stiffness.

In this case, the glass fiber as a stiffness reinforcing agent has an average diameter of from about 10 μm to about 20 μm (e.g., about 20 μm, about 21 μm, about 22 μm, about 23 μm, about 24 μm, about 25 μm, about 26 μm, about 27 μm, about 28 μm, about 29 μm, or about 30 μm) and a length of from about 3 mm to about 5 mm (e.g., about 3 mm, 4 mm or 5 mm) and may be surface-treated with epoxy-silane. When the average diameter is less than 10 μm or greater than 20 μm, there is a limitation in mass production and quality management in a process of making glass fiber, and thus it is exemplary that the glass fiber is used within the range. Further, while the glass fiber is smoothly injected into an extruder when mixed with a polymer, in order to maintain an initial length, the length of the glass fiber of from about 3 mm to about 5 mm is appropriate. Further, the glass fiber may be included with about 10 wt % to about 40 wt % with respect to the entire composition of the core portion. In addition, when the glass fiber is less than 10 wt %, there is a limitation in improvement of a mechanical property and fracture strength of the handle, and when the glass fiber is greater than 40 wt %, there is a limitation in that a reinforcing effect is not further increased and moldability is reduced. Thus, it is exemplary that the glass fiber is used within the range.

The core portion resin may be used by mixing from about 30 wt % to about 50 wt % (e.g., about 30 wt %, 35 wt %, 40 wt %, 45 wt %, or about 50 wt %) of ABS and from about 50 wt % to about 70 wt % (e.g., about 50 wt %, 55 wt %, 60 wt %, 65 wt %, or about 70 wt %) of PC with respect to 100 wt % of the entire core portion resin. When the polycarbonate is less than 50 wt %, there is a limitation in an effect of improving impact strength and a mechanical property, and when the polycarbonate is greater than 70 wt %, there is a limitation in that moldability is reduced. Thus, it is exemplary that the polycarbonate is used within the range.

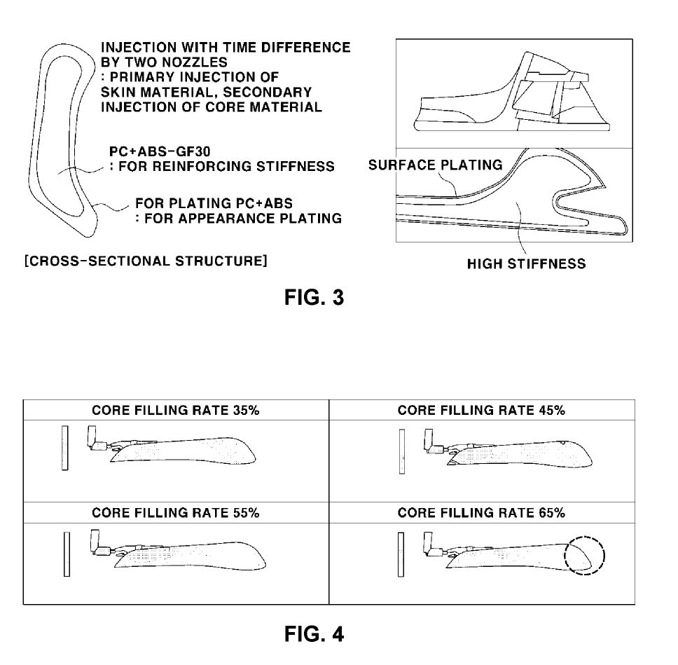

The present invention provides a method for manufacturing an inside door handle with a skin-core structure which is made by co-injecting the compositions made of the different materials. Referring to FIG. 2, in the present invention, two types of melted materials are injected with a time difference in one gate which is present in a pair of molds. First, the skin portion composition is primarily injected to the mold, the core portion composition is secondarily injected to the mold, and then the skin portion composition is injected to the mold again and sealed to implement a door handle with a completely closed structure. In this case, the time difference means a very short time interval within 1 second and the skin portion composition and the core portion composition are injected to the gate of the mold through different nozzles. FIG. 3 illustrates a cross section of an inside door handle with a closed type skin-core structure manufactured by the manufacturing method according to the present invention.

The core portion according to the present invention may be filled with the core portion composition at a filling ratio of from about 10 wt % to about 40 wt % (e.g., about 10 wt %, 15 wt %, 20 wt %, 25 wt %, 30 wt %, 35 wt %, or about 40 wt %) with respect to the entire door handle. More preferably, the core portion composition is filled with 30 to 40%. When the filling ratio is less than 10%, there is a limitation in improvement of the fracture strength of the handle and when the filling ratio is greater than 40%, there is a limitation in that the core material is exposed to the outside. Thus, it is exemplary that the filling ratio is within the range.

Accordingly, in the inside door handle manufactured by the composition and the manufacturing method, the core portion is filled at the filling rate of from about 10% to 40% (e.g., about 10%, 15%, 20%, 25%, 30%, 35%, or about 50%) with respect to the entire door handle. In addition, the skin portion and the core portion use different materials and the glass fiber is included in the core potion to improve the mechanical stiffness. In some cases, butadiene of the skin portion moves to the surface due to an increase in filling ratio of the core portion to improve a plating property, and a complete closed structure is implemented by co-injection to implement operability and quality improvement.

Hereinafter, the present invention will be described in more detail through Examples. However, these Examples are to exemplify the present invention and the scope of the present invention is not limited thereto.

### EXAMPLES

The following examples illustrate the invention and are not intended to limit the same.

### Examples 1 to 3 and Comparative Examples 1 to 8

According to compositions and contents in Table 1 below, a skin portion composition and a core portion composition were mixed with each other and prepared. Particularly, the skin portion composition and the core portion composition are injected into a mold of FIG. 2 with a time difference within 1 second through different nozzles to manufacture inside door handles of Examples 1 to 3 and Comparative Examples 1 to 8. In this case, the skin portion was used with 70 wt % and the core portion was used with 30 wt % with respect to the entire weight of the inside door handle. Accordingly, the filling ratio of the core portion was 30 wt %.

TABLE 1
Composition for making inside door handle with skin-core structure (unit: wt %)

| | | | | | Compar- | Compar- | Compar- | Compar- | Compar- | Compar- | Compar- | Compar- |
|---|---|---|---|---|---|---|---|---|---|---|---|---|
| | | | | | ative | ative | ative | ative | ative | ative | ative | ative |
| | | Exam- | Exam- | Exam- | Exam- | Exam- | Exam- | Exam- | Exam- | Exam- | Exam- | Exam- |
| Classification | | ple 1 | ple 2 | ple 3 | ple 1 | ple 2 | ple 3 | ple 4 | ple 5 | ple 6 | ple 7 | ple 8 |
| Skin | ABS | 50 | 50 | 50 | 50 | 50 | 50 | 50 | 50 | 50 | 100 | 50 |
| portion | PC | 50 | 50 | 50 | 50 | 50 | 50 | 50 | 50 | 50 | | 50 |
| | Total | 100 | 100 | 100 | 100 | 100 | 100 | 100 | 100 | 100 | 100 | 100 |
| | amount | | | | | | | | | | | |
| Core | ABS | 45 | 40 | 35 | 90 | 80 | 70 | | | | 100 | 50 |
| portion | PP | | | | | | | 90 | 80 | 70 | | |
| | PC | 45 | 40 | 35 | | | | | | | | 50 |
| | GF | 10 | 20 | 30 | 10 | 20 | 30 | 10 | 20 | 30 | | |
| | Total | 100 | 100 | 100 | 100 | 100 | 100 | 100 | 100 | 100 | 100 | 100 |
| | amount | | | | | | | | | | | |

*PP: Polypropylene
*PC: Polycarbonate
*ABS: Acrylonitrile-Butadiene-Styrene
*GF: Glass Fiber (surface-treated with epoxy-silane and having average diameter of 15 μm and length of 3 to 5 mm)

### Test Example 1

### Measurement of Mechanical Property

The results of the measurement were illustrated in Table 2 below by measuring properties of a specimen for the inside door handle manufactured in Examples 1 to 3 and Comparative Examples 1 to 8 by using the following test methods.

Measurement of tensile strength: Measured by ASTM D 638 method.

Measurement of flexural strength and flexural modulus: Measured by ASTM D790 method.

Measurement of izod impact strength: Measured by ASTM D 256 method.

Measurement of heat deflection temperature: Measured by ASTM D648 method.

TABLE 2
Result of measuring properties

| | | | | | | | | | | | | Compar- |
|---|---|---|---|---|---|---|---|---|---|---|---|---|
| | | | | | | | | | | | | ative |
| | | | | | | | | | | | | Exam- |
| | | | | | Compar- | Compar- | Compar- | Compar- | Compar- | Compar- | Compar- | ple 8 |
| | | | | | ative | ative | ative | ative | ative | ative | ative | (based on |
| Classi- | Desired | Exam- | Exam- | Exam- | Exam- | Exam- | Exam- | Exam- | Exam- | Exam- | Exam- | mass pro- |
| fication | value | ple 1 | ple 2 | ple 3 | ple 1 | ple 2 | ple 3 | ple 4 | ple 5 | ple 6 | ple 7 | duction) |
| Tensile | 50↑ | 88 | 93 | 103 | 59 | 83 | 88 | 54 | 64 | 76 | 48 | 48 |
| strength | | | | | | | | | | | | |
| Flexural | 80↑ | 137 | 137 | 167 | 98 | 127 | 142 | 69 | 108 | 118 | 66 | 78 |
| strength | | | | | | | | | | | | |
| Flexural | 4,000↑ | 4,805 | 5,296 | 7,432 | 3,727 | 4,394 | 6,355 | 2,354 | 3,726 | 4,998 | 2,247 | 2,371 |
| modulus | | | | | | | | | | | | |
| IZOD impact | 80↑ | 98 | 98 | 98 | 76 | 78 | 78 | 49 | 69 | 98 | 226 | 455 |
| strength | | | | | | | | | | | | |
| Heat | 90↑ | 115 | 116 | 118 | 97 | 98 | 99 | 130 | 140 | 150 | 85 | 96 |
| deflection | | | | | | | | | | | | |
| temperature | | | | | | | | | | | | |

As the result of Table 2, in the case of Examples 1 to 3 as the door handle with the skin-core structure made of different materials according to the present invention, it can be seen that all of the required mechanical properties of the inside door handle are satisfied.

### Comparative Examples 9 to 11

An inside door handle was manufactured by the same composition and the method as Example 3 and the core portion was filled by varying the filling ratio of the core portion according to a ratio in Table 3 below to manufacture the inside door handle.

TABLE 3
Filling ratio

| | Example | Comparative | Comparative | Comparative |
|---|---|---|---|---|
| Classification | 3 | Example 9 | Example 10 | Example 11 |
| Skin portion (wt %) | 70 | 55 | 45 | 35 |
| Core portion (wt %) | 30 | 45 | 55 | 65 |
| Filling ratio of core | 30% | 45% | 55% | 65% |
| portion (%) | | | | |

### TEST EXAMPLES

### Test Example 2

### Selection of Optimal Filling Ratio

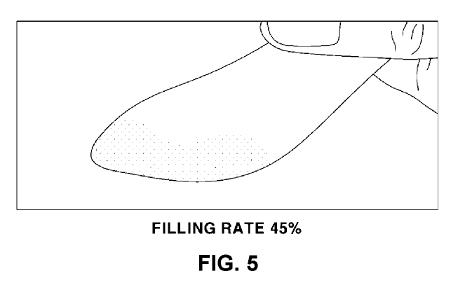

With respect to the door handle in Example 3 and Comparative Examples 9 to 11, a result of molding analysis is illustrated in FIG. 4. Furthermore, FIG. 5 illustrates an external appearance of a door handle having 45% of a filling ratio of a core portion which is actually injection-molded.

As the result of FIG. 4, it can be seen that when the filling ratio of the core portion is 30%, the door handle with the closed type skin-core structure without core surfacing of the core portion can be manufactured, whereas when the filling ratio is equal to or greater than 45%, the core surfacing of the core portion occurs.

### Test Example 3

### Measurement of Plating Property

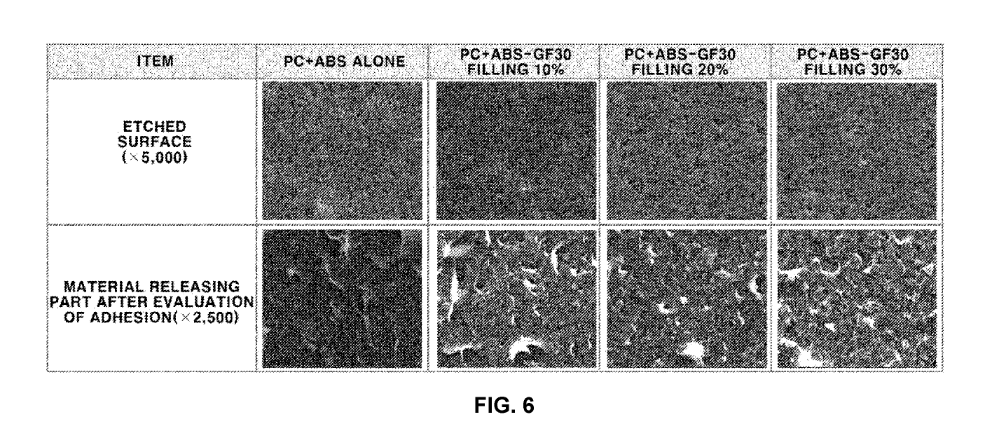

In order to determine excellent plating with respect to door handle specimens in Comparative Example 8 (based on mass production) and Examples 1 to 3, the door handle specimens were etched for 12 minutes at 68° C. in an aqueous solution in which chromic anhydride and sulfuric acid having concentrations of 440 g/L were mixed in a ratio of 1:1, respectively and an etched surface was observed by a scanning electron microscope (SEM), and the a morphological change of the etched surface was observed. FIG. 6 illustrates the results measured by the scanning electron microscope.

With respect to a component subjected to chemical plating and electric plating after etching, adhesion and fracture strength were measured by the following method and then the result thereof is illustrated in Table 4.

Measurement of adhesion: A sword line with a width of 10 mm was scored on the surface of the specimen up to the plastic material and the surface was released with a thickness of about 50 mm in a 90° direction, and then average releasing strength of the section except for the initial 5 mm was measured by a calculation method.

Measurement of fracture strength: A component was installed on a steel jig, a load was applied in an opened direction at a point of 70 mm from a hinge part, and the fracture strength was measured by a method of measuring a load when the handle was broken.

TABLE 4
Result of measuring adhesion and fracture strength

| | Comparative | | | |
|---|---|---|---|---|
| | Example 8 | | | |
| | (based on | | | |
| Classification | mass production) | Example 1 | Example 2 | Example 3 |
| Adhesion | 8.0 | 11.8 | 12.6 | 14.6 |
| Fracture strength | 52.0 | 75.4 | 80.0 | 70.4 |

As the result in Table 4, according to the present invention, in Examples 1 to 3, adhesion and fracture strength were excellent as compared with Comparative Example 8. In other words, this means that a plating property is excellent and is supported by FIG. 6.

As the result of FIG. 6, it can be seen that as the filling ratio of the core portion is increased, anchor holes are increased in morphology of the etched surface and a specific surface area of the surface is improved. It can be expected that while butadiene in the ABS resin of the skin portion moves to the surface when the filling ratio of the core portion is increased, the number of anchor holes during etching is increased. As a result, it can be seen that in the case of satisfying the filling ratio according to the present invention, plating adhesion is increased due to an increase in anchor holes when plating.

Therefore, in the composition and the manufacturing method according to the present invention, the mechanical property and the plating property are improved to provide an inside door handle with a skin-core structure made of different materials with ensured operability and quality. As a result, a problem of quality deterioration due to a plating release is resolved and material costs can be reduced by 10% or more as compared with mass-produced cars in the related art, and thus the present invention has excellent economic feasibility.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A resin composition for making an inside door handle with a skin-core structure, wherein a skin portion is made of a composition comprising an acrylonitrile-butadiene-styrene (ABS) resin alone or a mixture of from about 50 wt % to about 60 wt % of acrylonitrile-butadiene-styrene (ABS) and from about 40 wt % to about 50 wt % of polycarbonate (PC), and
a core portion is made of a composition comprising from about 60 wt % to about 90 wt % of a core portion resin comprising the ABS resin and the PC resin and from about 10 wt % to about 40 wt % of glass fiber for reinforcing stiffness.

2. The resin composition of claim 1, wherein the core portion resin is used by mixing from about 30 wt % to about 50 wt % of acrylonitrile-butadiene-styrene (ABS) and from about 50 wt % to about 70 wt % of polycarbonate (PC) with respect to 100 wt % of the entire core portion resin.

3. The resin composition of claim 1, wherein the glass fiber has an average diameter of from about 10 μam to about 20 μm and a length of from about 3 mm to about 5 mm and is surface-treated with epoxy-silane.

4. A method for manufacturing an inside door handle with a skin-core structure which is made by co-injecting a skin portion composition and a core portion composition with a time difference using the composition of claim 1.

5. The method of claim 4, wherein the co-injection is to inject the skin portion composition and the core portion composition into one gate which is present in a pair of molds with a time difference and the core portion is filled with a filling ratio of from about 10% to about 40% with respect to the entire door handle.

6. The method of claim 4, wherein the skin portion composition and the core portion composition are injected into the gate of the mold through different nozzles.

7. An inside door handle with a closed type skin-core structure manufactured by the manufacturing method of claim 4.
